(19) United States
(12) Patent Application Publication
(10) Pub. No.: US 2026/0120450 A1
(43) Pub. Date: Apr. 30, 2026

(54) FRACTIONAL FILTERS FOR CONVOLUTIONAL NEURAL NETWORK PROCESSING

(71) Applicant: Intel Corporation, Santa Clara, CA (US)

(72) Inventors: Julio Cesar Zamora Esquivel, West Sacramento, CA (US); Hector Alfonso Cordourier Maruri, Guadalajara (MX); Edgar Macias Garcia, Zapopan (MX); Rodrigo Aldana Lopez, Zapopan (MX); Paulo Lopez Meyer, Zapopan (MX); Leobardo E. Campos-Macias, Guadalajara (MX); Margarita Jauregui Franco, Zapopan (MX); Alejandro Ibarra Von Borstel, Buda, TX (US)

(73) Assignee: Intel Corporation, Santa Clara, CA (US)

(21) Appl. No.: 19/433,773

(22) Filed: Dec. 27, 2025

(51) Int. Cl. G06V 10/82; G06T 5/20

(52) U.S. Cl. CPC G06V 10/82; G06T 5/20

(57) ABSTRACT

Techniques for applying filters in a convolutional neural networks (CNN) are described. In some examples, one or more filters of the CNN are mathematically defined. In some examples, one or more trainable parameter of the filters allow for a family of filters. In some examples, the family of filters is Gaussian-based. In some examples, the sizes of filters in the CNN are dynamically adjusted. For example, the sizes of the filters are adjusted based on the accuracy of a result (e.g., if not accurate enough, then a larger filter is used, etc.).

### BACKGROUND

Neural networks and other types of machine learning models are useful tools that have demonstrated their value solving complex problems regarding pattern recognition, natural language processing, automatic speech recognition, etc. Neural networks operate using artificial neurons arranged into one or more layers that process data from an input layer to an output layer, applying weighting values to the data during the processing of the data. Such weighting values are determined during a training process and applied during an inference process.

### BRIEF DESCRIPTION OF DRAWINGS

Various examples in accordance with the present disclosure will be described with reference to the drawings, in which:

FIG. 1 illustrates examples of neural network topology implementing fractional convolutional kernels.

FIG. 2 illustrates examples of one dimensional filters.

FIG. 3 illustrates examples of multi-dimensional filters.

FIG. 4 illustrates examples of an application of different sized filters ad different locations.

FIG. 5 illustrates examples filtering options on the same image.

FIG. 6 illustrates examples of methods training and/or performing inference using a convolutional neural network that uses kernels of different sizes and/or uses convolutional kernels that are mathematically defined.

FIG. 7 is a schematic diagram of an illustrative electronic computing device to enable fractional convolutional kernels, according to some embodiments.

FIG. 8 illustrates an example computing system.

FIG. 9 illustrates a block diagram of an example processor and/or System on a Chip (SoC) that may have one or more cores and an integrated memory controller.

### DETAILED DESCRIPTION

The present disclosure relates to methods, apparatus, systems, and non-transitory computer-readable storage media for fractional filter usage in convolutional neural networks.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In some examples disclosed herein, a convolutional neural network is used. Using a convolutional neural network enables classification of objects in images, natural language processing, etc. In general, machine learning models/architectures that are suitable to use in the example approaches disclosed herein may include convolutional neural networks. However, other types of machine learning models could additionally or alternatively be used such as recurrent neural network, feedforward neural network, etc.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

Convolutional Neural Networks (CNNs) filter input data (e.g., images or subsets thereof) using kernels. Traditionally, these kernels are a fixed configurable element size such as 3×3, 5×5, or 7×7 elements. During training, the value of each element in the kernels is improved following an optimization rule (for example, using stochastic gradient descent SGD). Convolution extracts features from the input. In image processing, there is a wide range of different filters one could choose for convolution. Each type of filter helps to extract different aspects or features from the input image, such as horizontal, vertical, and/or diagonal edges, for example. Similarly, in CNNs, different features are extracted through convolution using filters whose weights are automatically learned during training. The extracted features then are “combined” to make decisions.

There are advantages to performing convolution such as weights sharing and translation invariant. Convolution also takes spatial relationship of pixels into consideration. This could be helpful in many computer vision tasks, since those tasks often involve identifying objects where certain components have certain spatial relationships with other components (e.g. a dog's body usually links to a head, four legs, and a tail, etc.).

CNNs may be described as using a filter or a kernel. In some examples, the difference between a filter and kernel is subtle. Sometimes, the terms filter and kernel are used interchangeably. However, these two terms may have a difference. A term “kernel” refers to a 2D array of weights. The term “filter” refers to a 3D structure of multiple kernels stacked together. For a 2D filter, a filter refers to the same thing as a kernel. However, for a 3D filter and most convolutions in deep learning, a filter is a collection of kernels. Each kernel is an individualized kernel, emphasizing different aspects of the input channel.

A multi-channel convolution works as follows. Each kernel is applied onto an input channel of the previous layer to generate one output channel. This is a kernel-wise process. Such process is repeated for all kernels to generate multiple channels. Each of these channels are then summed together to form one single output channel.

A problem encountered with conventional systems that implement kernels of fixed configurable sizes is that the number of trainable parameters per filter is equal to the number of elements in the kernel. This has an impact on training time and memory requirements. For example, either 9, 25 or 49 trainable parameters may be utilized for kernels of size 3×3, 5×5 and 7×7 respectively. Thus, a challenge exists in reducing the number of trainable parameters per kernel so that the CNN is trained faster and utilizes less memory.

Examples detailed herein allow for CNNs that can adjust the size of the convolutional kernels on-the-fly at inference time increasing the kernel size when more accuracy is needed and reducing it when there is enough confidence and/or use a mathematical definition of a kernel.

Implementations of the disclosure provide for replacing traditional filters at the input of CNNs with a generalized “fractional filter” (also referred to herein as a fractional convolutional kernel). The proposed fractional filter utilizes the concept of fractional derivatives from fractional calculus. The proposed fractional convolutional kernel of implementations of the disclosure can replace the traditional convolutional filters of CNNs because the fractional convolutional kernel behaves in the same way as a Gaussian, Sobel, Derivative of Gaussian (DoG), Laplacian of Gaussian (LoG), etc. filters. Moreover, the fractional convolutional kernel can also be configured to generate novel filters not previously defined that can be envisioned as intermediate steps between each of the above-mentioned filters (e.g., Gaussian, Sobel, DoG, LoG, Mexican hat, etc.) In one implementation, the proposed fractional convolutional kernel of implementations of the disclosure is defined using five dynamic parameters (including a fractional derivative, standard deviation, amplitude, amplitude, an X offset, and a Y offset) and is based on a gamma function.

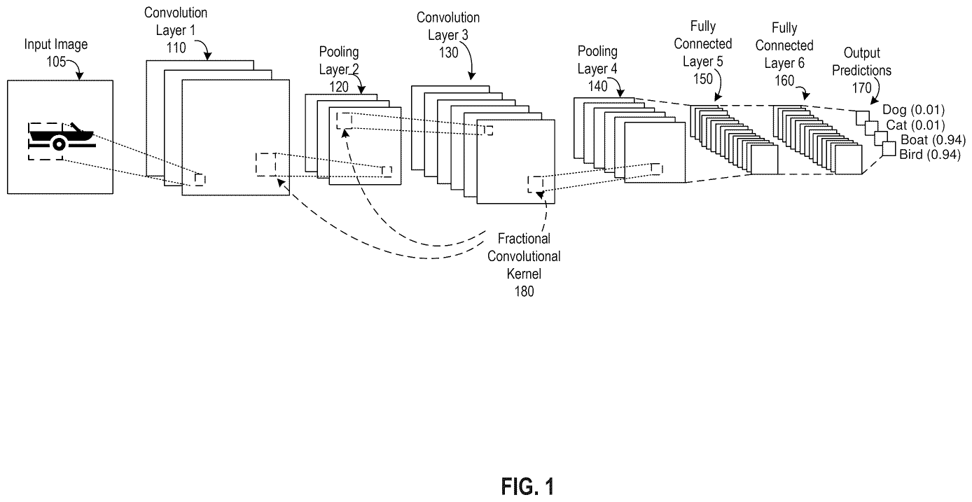

FIG. 1 illustrates examples of neural network topology implementing fractional convolutional kernels. The neural network topology depicts an input image 105 being processed by the example neural network topology. In implementations of the disclosure, other types of input data than image data may be processed by neural network topology (e.g., radiation patterns, etc.) and implementations of the disclosure can be expanded to process a variety of types of input data. However, for ease of explanation and discussion, the following description refers to the input data as input image 105.

The neural network topology is depicted as processing the input image 105 using multiple layers including, but not limited to, convolutional layer 1 110, pooling layer 2 120, convolutional layer 3 130, pooling layer 4 140, fully connected layer 5 150, fully and connected layer 6 160. The processing of the input image 105 by the layers 110-160 results in one or more output predictions 170 (e.g., classifications (such as dog, cat, boat, bird in the example of neural network topology), etc.) with respect to the input image 105. In implementations of the disclosure, one or more of the neural network layers 110-160 may implement the fractional convolutional kernel 180, as described herein, to perform convolutions of data associated with the input image 105 in order to contribute to generation of the output predictions 170.

Examples detailed herein allow for the active (e.g., during inference) changing of a convolutional kernel size used in a convolutional layer (e.g., a layer such as convolutional layer 1 110, etc.). In some examples, a kernel is mathematically defined in a manner that is not dependent on the kernel size. In some examples, different size kernels will be used depending on the location in the source. For example, a kernel of a first size is used on border pixels and a kernel of a second, larger size is used on internal pixels.

In some examples, the mathematical definition of a kernel is as shown in equation 1 below:

$$f ( x ) = - sin ( ( \frac{π}{4} - a ) x - a ) {e}^{- {x}^{2}} \qquad ( 1 )$$

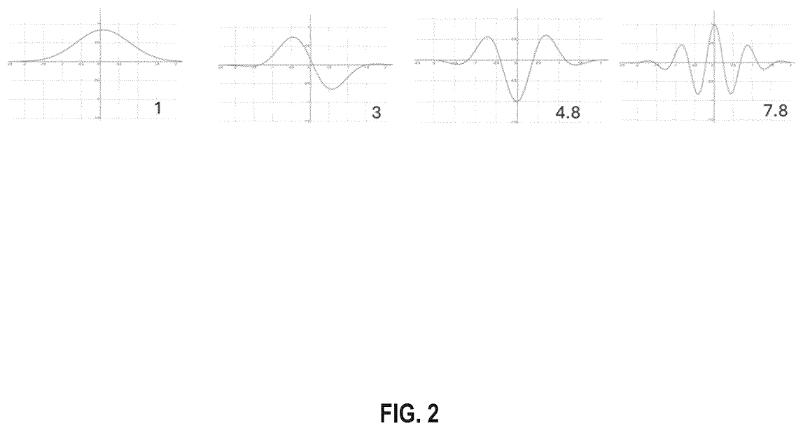

A parameter of this definition is trainable and that is parameter a. Note that this filter is for the “x-axis.” FIG. 2 illustrates examples of one dimensional filters. Different combinations of the trainable parameter allows for the generation different filters. Using the above equation the family of filters that can be generated are Gaussian. For example, a Gaussian filter, a DoG (Difference of Gaussians) filter, a LoG (Laplacian of Gaussian) filter, etc. by adjusting the parameters. As such, a filter can be trained independent of its size by adjusting the trainable parameters and the size can be selected at inference.

Other axes are defined using their own trainable parameter. For example, equation 1 may be altered to account for another axis (e.g., the “y-axis”) with the trainable parameter b:

$$f ( y ) = - sin ( ( \frac{π}{4} - b ) y - b ) {e}^{- {y}^{2}} \qquad ( 2 )$$

A two-dimensional (2-D) filter Z is generated by z(x, y)=f(x)f(y). A 3-D filter would be generated by z(x, y, w)=f(x)f(y)f(w), etc. The trainable parameters a and b expand a family of filters.

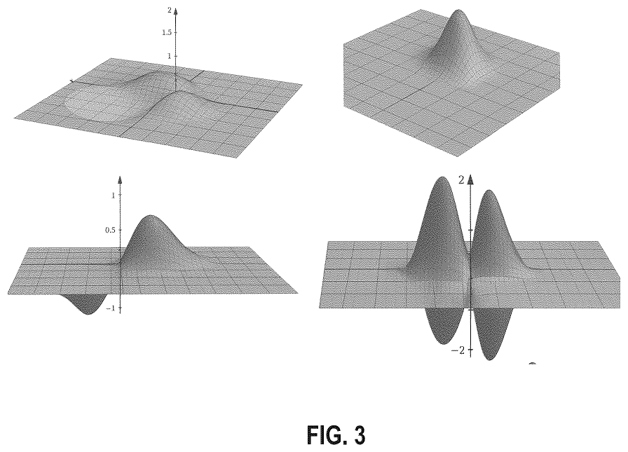

FIG. 3 illustrates examples of multi-dimensional filters. Different combinations of the trainable parameters allow for the generation different filters. Using the above equations the family of filters that can be generated are Gaussian. For example, a Gaussian filter, a DoG (Difference of Gaussians) filter, a LoG (Laplacian of Gaussian) filter, etc. by adjusting the parameters. As such, a filter can be trained independent of its size by adjusting the trainable parameters and the size can be selected at inference.

Additionally, the equations above may be used to define a particular family of kernel generators. This family is useful since it covers classical filters commonly used in computer vision and image processing and is known to detect features such as corners or lines. However, other kernel families may be generated, which depend on lower dimensional parameter spaces. For instance, Fourier series filters, polynomial filters, neural operator filters, etc. can be used. Note that any such parameterization is independent of the required kernel sizes.

Typically, when convolution using a 3×3 filters (without padding) results in a loss of the first and the last columns and rows. Using a larger filter (e.g., a 5×5 filter) causes a loss of more columns and rows (e.g., the two initial and the last two columns and rows). This means that the filter size cannot be changed without affecting the CNN topology overall.

In some examples, the way in which convolutional filters are applied is dependent on the location of the data to be convolved. For example, a filter of a first size is used on a first set of data elements at a particular location and a filter of a second size is used on a second set of data elements at a different location. For example, a first filter size may be used on “external” data (or border data or border columns and rows) and “internal” data (all other data locations).

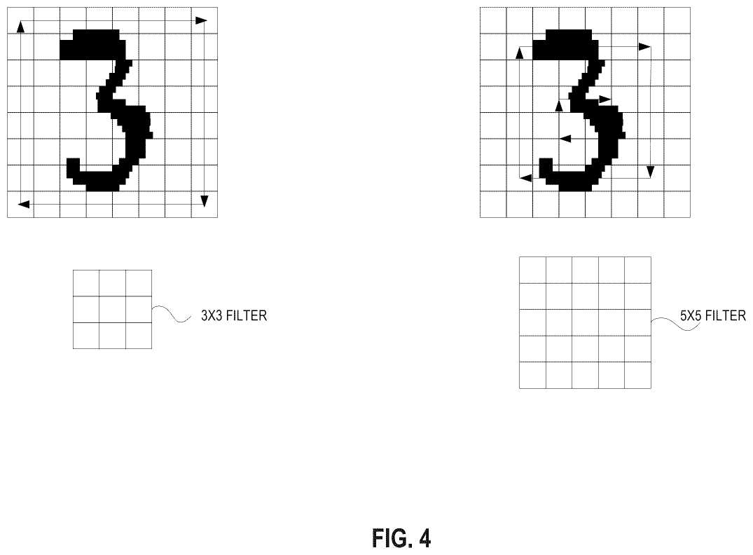

FIG. 4 illustrates examples of an application of different sized filters ad different locations. In this illustration, the outside of the image is convolved using a 3×3 filter. The interior of the image is convolved using a 5×5 filter. Note that the interior may still be convolved with a smaller filter.

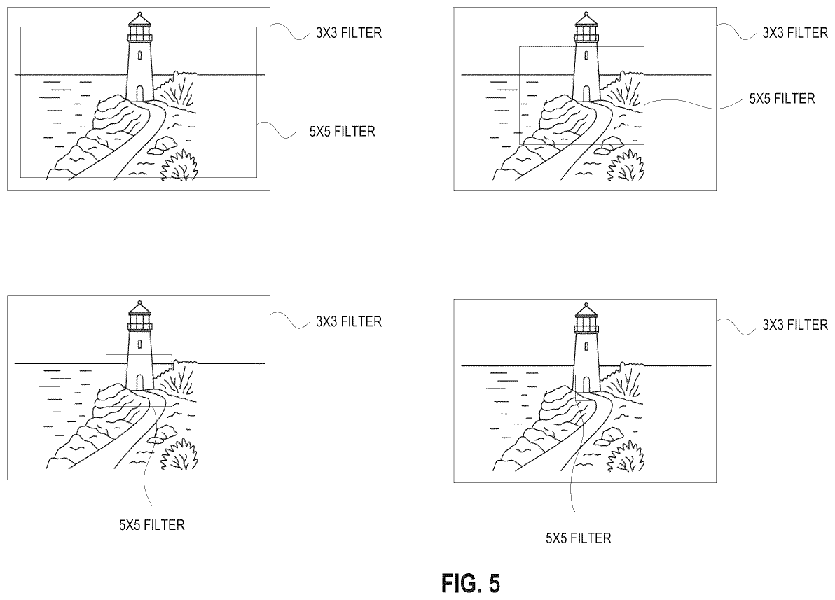

FIG. 5 illustrates examples filtering options on the same image. In the upper left, the image if filter using a 3×3 filter on the border and a 5×5 filter elsewhere. The upper right uses the 3×3 filter for more of the image, etc. The use of the 3×3 filter requires less processing resources at worse performance. The selection of when to use certain sized filters (without changing the shape of the CNN topology) allows for a better balance of resource usage and performance can be achieved.

An example of pseudocode that allows for both different sized filters and filters that are mathematically defined is as follows:

```
class ParallelFracKernels_ResizableFast(nn.Module):
  def _{——}init_{——}(self,cinputs, nChannels,Ksize,cStride,cPadding,training):
    super(ParallelFracKernels_ResizableFast, self)._{——}init_{——}( )
    self.a =
torch.nn.Parameter(data=torch.zeros((cinputs,nChannels)),requires_grad=training)#initi
alization
    self.b =
torch.nn.Parameter(data=torch.zeros((cinputs,nChannels)),requires_grad=training)#initi
alization
    torch.nn.init.xavier_normal_(self.a)
    torch.nn.init.xavier_normal_(self.b)
    self.nChannels = nChannels
    self.k_size = Ksize
    self.h=0.5
    self.nInputs=cinputs
    self.stride=cStride
    self.padding=cPadding
    self.dtype = torch.cuda.FloatTensor
    self.dtype_int = torch.cuda.LongTensor
    self._reversed_padding_repeated_twice = _reverse_repeat_tuple((cPadding,
cPadding), 2)
// FILTERS DEFINED MATHEMATICALLY
  def Fltr(self):
    ampy=−2*torch.sin((0.785−self.b.unsqueeze(2)*self.one)*(self.ind)−
self.b.unsqueeze(2)*self.one)
    teMvy=torch.exp(−torch.pow(self.ind,2))*ampy
    amp=−2*torch.sin((0.785−self.a.unsqueeze(2)*self.one)*(self.ind)−
self.a.unsqueeze(2)*self.one)
    teMvx=torch.exp(−torch.pow(self.ind,2))*amp
    s=torch.matmul(teMvy.unsqueeze(3),teMvx.unsqueeze(2))
    return s
  def FltrX(self,M,D):
    #ind2=torch.zeros(M).type(self.dtype)
    ind2=torch.zeros(M, device=D,requires_grad=False)
    one2=torch.ones(M).type(self.dtype)
    #for i in torch.arange(0,M).type(torch.cuda.FloatTensor):
    # ind2[int(i)]=i
    for i in torch.arange(0,M, device=D):
        ind2[int(i)]=i−(M−1)/2
    ampy=−2*torch.sin((0.785−self.b.unsqueeze(2)*one2)*(ind2)−
self.b.unsqueeze(2)*one2)
    teMvy=torch.exp(−torch.pow(ind2,2))*ampy
    amp=−2*torch.sin((0.785−self.a.unsqueeze(2)*one2)*(ind2)−
self.a.unsqueeze(2)*one2)
    teMvx=torch.exp(−torch.pow(ind2,2))*amp
    s=torch.matmul(teMvy.unsqueeze(3),teMvx.unsqueeze(2))
    return s
  def forward(self, x):
    with torch.no_grad( ):
      self.a[:]=self.a.clamp(−3.14,3.14)
      self.b[:]=self.b.clamp(−3.14,3.14)
    #self.ind=torch.zeros(self.k_size, device=x.device,requires_grad=False)
    #self.one=torch.ones(self.k_size, device=x.device,requires_grad=False)
    #for i in torch.arange(0,self.k_size, device=x.device):
    # self.ind[int(i)]=i−(self.k_size−1)/2
    #Ker=self.Fltr( )
// DIFFERENT SIZE FILTERS
    Ker3=self.FltrX(3,x.device)
    Ker5=self.FltrX(5,x.device)
    output1 = F.conv2d(F.pad(x, self._reversed_padding_repeated_twice),
          Ker3.permute((1,0,2,3)), None, (self.stride, self.stride),
          _pair(0), 1)
    output2 = F.conv2d(F.pad(x, self._reversed_padding_repeated_twice),
          Ker5.permute((1,0,2,3)), None, (self.stride, self.stride),
          _pair(0), 1)
    border=12
    Mask=torch.ones(output1.shape[0],output1.shape[1],output1.shape[2]−
2*border,output1.shape[2]−2*border).type(self.dtype)
    Mask = F.pad(Mask,(border,border,border,border))
Mask2=torch.ones(output1.shape[0],output1.shape[1],output1.shape[2],output1.shape[
2]).type(self.dtype)
    Mask2=Mask2−Mask;
    #print(output1.shape)
    output =output1*Mask2+F.pad(output2,(1,1,1,1))*Mask;
    #output=output1+output2
    return output
```

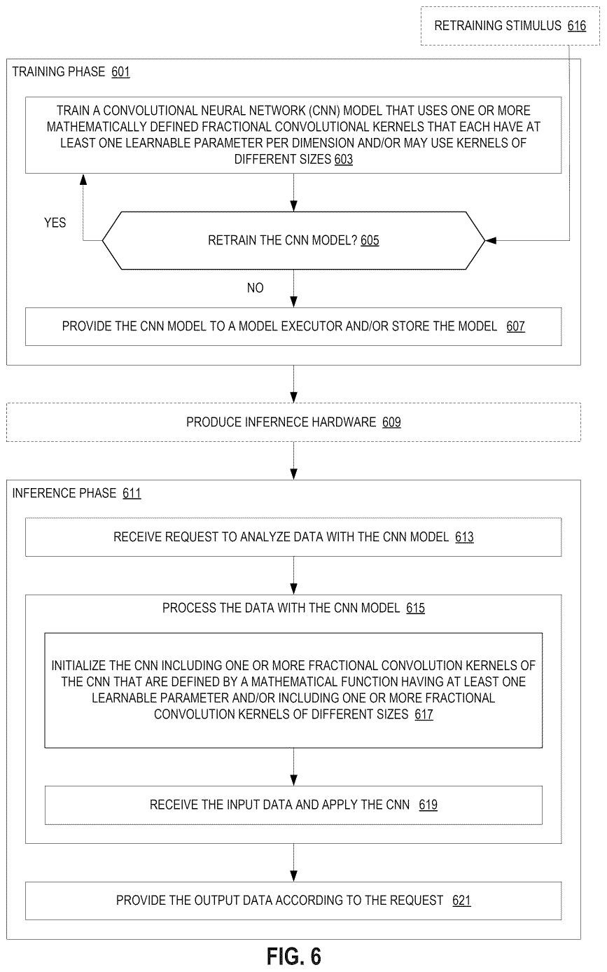

FIG. 6 illustrates examples of methods training and/or performing inference using a convolutional neural network that uses kernels of different sizes and/or uses convolutional kernels that are mathematically defined. Examples of methods may be performed by processing logic that may comprise hardware (e.g., circuitry, dedicated logic, programmable logic, etc.), software (such as instructions run on a processing device), or a combination thereof. More particularly, the examples of the method may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

A training phase 601 includes training a convolutional neural network (CNN) model that uses one or more mathematically defined fractional convolutional kernels that each have at least one learnable parameter per dimension and/or may use kernels of different sizes at 603. In some examples, the training phase is performed using a service. In some examples, the model is trained such that it adjusts the sizes of the filters based on a desired accuracy. In some examples, the model takes in a location where a higher accuracy is desired (e.g., a user provided bounding box).

In some examples, if a model trainer determines at 605 that the model should be retrained, it is retrained at 603. In examples, a retraining stimulus 616 is used to kick off retraining. An example of a stimulus is labeled distributions exceeding a retrain limit threshold. In other examples, the model retraining stimulus 616 is input from a user indicating that the model should be retrained. In some examples, retraining stimulus 616 is an amount of time since the model was last trained.

If the model is to not be retrained, the model is provided a model executor (e.g., a model execution service and/or is stored (e.g., using a model storage service) at 607.

In examples disclosed herein, the model is provided to a system to convert the model into a fully pipelined inference hardware format at 609. In other examples, the model is provided over a network such as the Internet.

An inference phase 611 is used to perform inferencing using the trained model. An inference may be performed on various types of data such as text, images, point-cloud data, video, speech, etc. During the inference phase 611 a request to analyze data with the CNN model is received at 613. The request may indicate one or more of the data to process, an indication of a location of the data to process, an indication of the CNN model to use, an indication of how to provide a result of the inference, an indication of the kernel sizes to use, an indication of a level of accuracy that is desired (which may result in changing kernel sizes), an indication of a location of an area to be processed with higher accuracy, an indication of the type of filter to use (which allows for a selection of corresponding learned parameters), an indication of complexity of the input data, an indication of a confidence threshold, etc.

The input data is processed using the CNN at 615. The CNN including one or more fractional convolution kernels of the CNN that are defined by a mathematical function having at least one learnable parameter and/or including one or more fractional convolution kernels of different sizes is initialized at 617. This initialization may include configuring the kernel sizes based on input from the request (e.g., complexity of the data, confidence threshold, accuracy threshold, etc.). In some examples, a user provides an indication of a threshold such as a complexity, confidence, or accuracy threshold. In some examples, a determination of at least one of these thresholds is programmatically determined (for example, a determination is made of how complex an image (e.g., by identifying how different each pixel is from its neighbors, using Minium Description Length to separate patterns from random noise, etc.). In some examples, the kernel sizes are adjusted based on a result (e.g., lacking accuracy such as a tracked user is not longer tracked, etc.).

The data to process is received and the CNN applied at 619 to generate a result. In some examples, an accuracy measurement of the output is determined. If the accuracy is not good enough (e.g., does not meet a supplied threshold (which may be user or programmatically defined, in some examples the CNN is adjusted). In some examples, a CNN is invoked at 619 which generates the filters to use.

An output of the CNN is provided according to the request at 621.

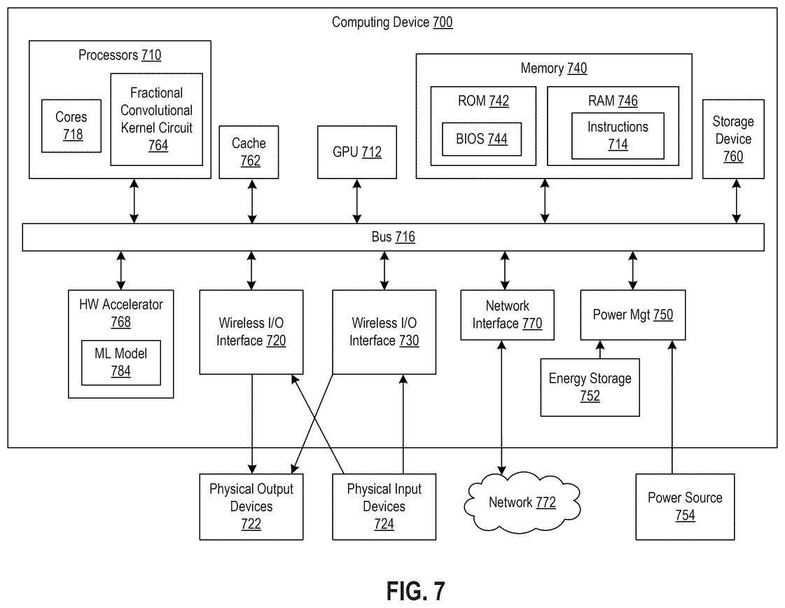

FIG. 7 is a schematic diagram of an illustrative electronic computing device to enable fractional convolutional kernels, according to some embodiments. In some embodiments, the computing device 700 includes one or more processors 710 including one or more processors cores 718 and a fractional convolutional kernel circuit 764, the fractional convolutional kernel circuit 764 to enable fractional convolutional kernels in neural networks. In some embodiments, the computing device 700 includes a hardware accelerator 768, the hardware accelerator including a machine learning model 784. In some embodiments, the computing device is to implement fractional convolutional kernels in neural networks implementing the machine learning model 784.

The computing device 700 may additionally include one or more of the following: cache 762, a graphical processing unit (GPU) 712 (which may be the hardware accelerator in some implementations), a wireless input/output (I/O) interface 720, a wired I/O interface 730, memory circuitry 740, power management circuitry 750, non-transitory storage device 760, and a network interface 770 for connection to a network 772. The following discussion provides a brief, general description of the components forming the illustrative computing device 700. Example, non-limiting computing devices 700 may include a desktop computing device, blade server device, workstation, or similar device or system.

In embodiments, the processor cores 718 are capable of executing machine-readable instruction sets 714, reading data and/or instruction sets 714 from one or more storage devices 760 and writing data to the one or more storage devices 760. Those skilled in the relevant art can appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like. For example, machine-readable instruction sets 714 may include instructions to implement fractional convolutional kernels, as provided in FIGS. 1-10.

The processor cores 718 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 700 includes a bus or similar communications link 716 that communicably couples and facilitates the exchange of information and/or data between various system components including the processor cores 718, the cache 762, the graphics processor circuitry 712, one or more wireless I/O interfaces 720, one or more wired I/O interfaces 730, one or more storage devices 760, and/or one or more network interfaces 770. The computing device 700 may be referred to in the singular herein, but this is not intended to limit the embodiments to a single computing device 700, since in some embodiments, there may be more than one computing device 700 that incorporates, includes, or contains any number of communicably coupled, collocated, or remote networked circuits or devices.

The processor cores 718 may include any number, type, or combination of currently available or future developed devices capable of executing machine-readable instruction sets.

The processor cores 718 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 7 are of conventional design. Consequently, such blocks do not have to be described in further detail herein, as they can be understood by those skilled in the relevant art. The bus 716 that interconnects at least some of the components of the computing device 700 may employ any currently available or future developed serial or parallel bus structures or architectures.

The system memory 740 may include read-only memory (“ROM”) 742 and random access memory (“RAM”) 746. A portion of the ROM 742 may be used to store or otherwise retain a basic input/output system (“BIOS”) 744. The BIOS 744 provides basic functionality to the computing device 700, for example by causing the processor cores 718 to load and/or execute one or more machine-readable instruction sets 714. In embodiments, at least some of the one or more machine-readable instruction sets 714 cause at least a portion of the processor cores 718 to provide, create, produce, transition, and/or function as a dedicated, specific, and particular machine, for example a word processing machine, a digital image acquisition machine, a media playing machine, a gaming system, a communications device, a smartphone, or similar.

The computing device 700 may include at least one wireless input/output (I/O) interface 720. The at least one wireless I/O interface 720 may be communicably coupled to one or more physical output devices 722 (tactile devices, video displays, audio output devices, hardcopy output devices, etc.). The at least one wireless I/O interface 720 may communicably couple to one or more physical input devices 724 (pointing devices, touchscreens, keyboards, tactile devices, etc.). The at least one wireless I/O interface 720 may include any currently available or future developed wireless I/O interface. Example wireless I/O interfaces include, but are not limited to: BLUETOOTH®, near field communication (NFC), and similar.

The computing device 700 may include one or more wired input/output (I/O) interfaces 730. The at least one wired I/O interface 730 may be communicably coupled to one or more physical output devices 722 (tactile devices, video displays, audio output devices, hardcopy output devices, etc.). The at least one wired I/O interface 730 may be communicably coupled to one or more physical input devices 724 (pointing devices, touchscreens, keyboards, tactile devices, etc.). The wired I/O interface 730 may include any currently available or future developed I/O interface. Example wired I/O interfaces include, but are not limited to: universal serial bus (USB), IEEE 1394 (“FireWire”), and similar.

The computing device 700 may include one or more communicably coupled, non-transitory, data storage devices 760. The data storage devices 760 may include one or more hard disk drives (HDDs) and/or one or more solid-state storage devices (SSDs). The one or more data storage devices 760 may include any current or future developed storage appliances, network storage devices, and/or systems. Non-limiting examples of such data storage devices 760 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 760 may include one or more removable storage devices, such as one or more flash drives, flash memories, flash storage units, or similar appliances or devices capable of communicable coupling to and decoupling from the computing device 700.

The one or more data storage devices 760 may include interfaces or controllers (not shown) communicatively coupling the respective storage device or system to the bus 716. The one or more data storage devices 760 may store, retain, or otherwise contain machine-readable instruction sets, data structures, program modules, data stores, databases, logical structures, and/or other data useful to the processor cores 718 and/or graphics processor circuitry 712 and/or one or more applications executed on or by the processor cores 718 and/or graphics processor circuitry 712. In some instances, one or more data storage devices 760 may be communicably coupled to the processor cores 718, for example via the bus 716 or via one or more wired communications interfaces 730 (e.g., Universal Serial Bus or USB); one or more wireless communications interfaces 720 (e.g., Bluetooth®, Near Field Communication or NFC); and/or one or more network interfaces 770 (IEEE 802.3 or Ethernet, IEEE 802.11, or Wi-Fi®, etc.).

Processor-readable instruction sets 714 and other programs, applications, logic sets, and/or modules may be stored in whole or in part in the system memory 740. Such instruction sets 714 may be transferred, in whole or in part, from the one or more data storage devices 760. The instruction sets 714 may be loaded, stored, or otherwise retained in system memory 740, in whole or in part, during execution by the processor cores 718 and/or graphics processor circuitry 712.

The computing device 700 may include power management circuitry 750 that controls one or more operational aspects of the energy storage device 752. In embodiments, the energy storage device 752 may include one or more primary (i.e., non-rechargeable) or secondary (i.e., rechargeable) batteries or similar energy storage devices. In embodiments, the energy storage device 752 may include one or more supercapacitors or ultracapacitors. In embodiments, the power management circuitry 750 may alter, adjust, or control the flow of energy from an external power source 754 to the energy storage device 752 and/or to the computing device 700. The power source 754 may include, but is not limited to, a solar power system, a commercial electric grid, a portable generator, an external energy storage device, or any combination thereof.

For convenience, the processor cores 718, the graphics processor circuitry 712, the wireless I/O interface 720, the wired I/O interface 730, the storage device 760, and the network interface 770 are illustrated as communicatively coupled to each other via the bus 716, thereby providing connectivity between the above-described components. In alternative embodiments, the above-described components may be communicatively coupled in a different manner than illustrated in FIG. 7. For example, one or more of the above-described components may be directly coupled to other components, or may be coupled to each other, via one or more intermediary components (not shown). In another example, one or more of the above-described components may be integrated into the processor cores 718 and/or the graphics processor circuitry 712. In some embodiments, all or a portion of the bus 716 may be omitted and the components are coupled directly to each other using suitable wired or wireless connections.

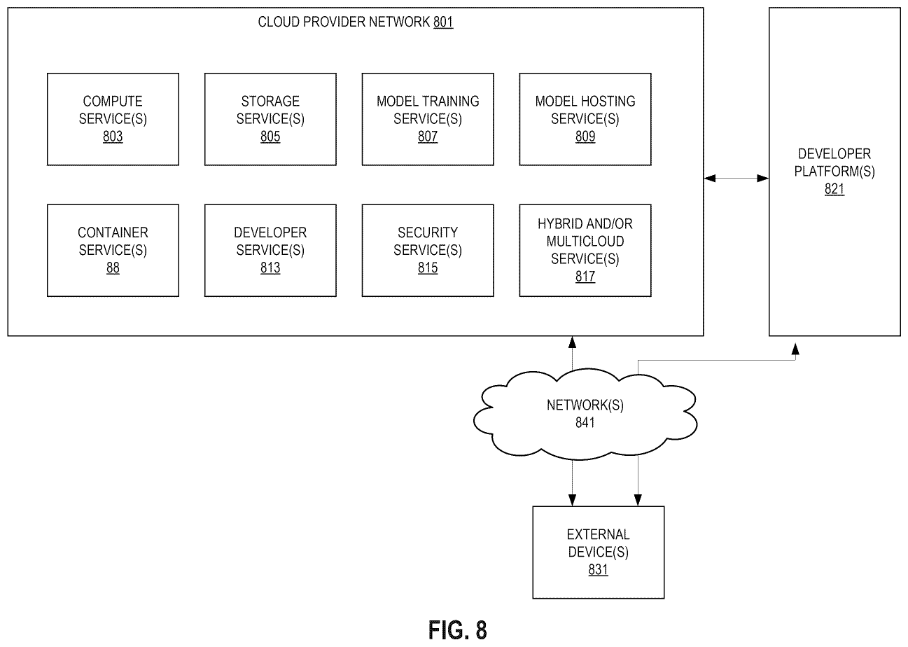

In some examples, a cloud provider network provides a service that allows for CNN training and/or inference as detailed above. FIG. 8 illustrates examples of a cloud provider network. The example cloud provider network 801 includes a plurality of services.

In some examples, one or more compute services 803 provide cloud compute capacity, virtualization, and scaling. In some examples, one or more of these services allows for the containerization of applications, deployment to virtual machines (VMs), etc. These compute services support a plurality of different instance types (e.g., CPU, GPU, accelerators, etc.) and/or memory support (e.g., an amount of RAM, etc.). In some examples, the compute services support a dedicated host, container hosting, a compute fleet, OS servers, etc.

In some examples, one or more storage services 805 provide cloud storage. For example, these storage services may include databases, disk storage, blob storage, data lake storage, file syncing with on-premises data, container storage, etc.

In some examples, one or more model training services 807 provide support for training of a ML model. In some examples, the CNN training described above is supported through a command line interface or graphical user interface input. The model training services support one or more of bot development, searching, model training, model validation, computer vision, etc.

In some examples, one or more model hosting services 809 allow for a trained model to be deployed and hosted within the cloud provider network. For example, CNN inference may be supported using one of these services.

In some examples, one or more container services 811 support the development and deployment of containerized software. In some examples, these services include a registry to build, store, secure, and/or replicate containers. In some examples, these services support storage for containers.

In some examples, one or more developer services 813 support the development of code. For example, these services may provide an integrated development environment (IDE), code debugging, software development kits (SDKs), load testing, code generation, etc.

In some examples, one or more security services 815 protect applications, data, and/or cloud infrastructure. These services may include threat protection, cryptographic key management, denial of service protection, information protection (e.g., protecting emails, documents, etc.), attestation of trusted execution environments, etc.

In some examples, one or more hybrid and/or multi-cloud services 817 allow for the synchronization of cloud and on-premises directories, data, etc. These services may also provide for running local VMs, containers, and cloud provider network services.

Developer platform(s) 821 allow for storage, editing, etc. of software development projects. In some examples, code for DNN training may be stored using a developer platform.

External device(s) 831 connect to the cloud provider network 801 and/or developer platform(s) 821 through one or more networks 841.

### Example Architectures

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

### Example Systems

FIG. 8 illustrates an example computing system. Multiprocessor system 800 is an interfaced system and includes a plurality of processors or cores including a first processor 870 and a second processor 880 coupled via an interface 850 such as a point-to-point (P-P) interconnect, a fabric, and/or bus. In some examples, the first processor 870 and the second processor 880 are homogeneous. In some examples, first processor 870 and the second processor 880 are heterogenous. Though the example multiprocessor system 800 is shown to have two processors, the system may have three or more processors, or may be a single processor system. In some examples, the computing system is a system on a chip (SoC).

Processors 870 and 880 are shown including integrated memory controller (IMC) circuitry 872 and 882, respectively. Processor 870 also includes interface circuits 876 and 878; similarly, second processor 880 includes interface circuits 886 and 888. Processors 870, 880 may exchange information via the interface 850 using interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a network interface (NW I/F) 890 via individual interfaces 852, 854 using interface circuits 876, 894, 886, 898. The network interface 890 (e.g., one or more of an interconnect, bus, and/or fabric, and in some examples is a chipset) may optionally exchange information with a co-processor 838 via an interface circuit 892. In some examples, the co-processor 838 is a special-purpose processor, such as, for example, a high-throughput processor, a network or communication processor, a compression engine, a graphics processor, a general purpose graphics processing unit (GPGPU), a neural-network processing unit (NPU), an embedded processor, a security processor, a cryptographic accelerator, a matrix accelerator, an in-memory analytics accelerator, a data streaming accelerator, data graph operations, or the like.

A shared cache (not shown) may be included in either processor 870, 880 or outside of both processors, yet connected with the processors via an interface such as P-P interconnect, such that either or both processors' local cache information may be stored in the shared cache if a processor is placed into a low power mode.

Network interface 890 may be coupled to a first interface 816 via interface circuit 896. In some examples, first interface 816 may be an interface such as a Peripheral Component Interconnect (PCI) interconnect, a PCI Express interconnect or another I/O interconnect. In some examples, first interface 816 is coupled to a power control unit (PCU) 817, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interface 816, along with a bus bridge 818 which couples first interface 816 to a second interface 820. In some examples, one or more additional processor(s) 815, such as co-processors, high throughput many integrated core (MIC) processors, GPGPUs, accelerators (such as graphics accelerators or digital signal processing (DSP) units), field programmable gate arrays (FPGAs), or any other processor, are coupled to first interface 816. In some examples, second interface 820 may be a low pin count (LPC) interface. Various devices may be coupled to second interface 820 including, for example, a keyboard and/or mouse 822, communication devices 827 and storage circuitry 828. Storage circuitry 828 may be one or more non-transitory machine-readable storage media as described below, such as a disk drive or other mass storage device which may include instructions/code and data 830 and may implement the storage ‘ISAB03 in some examples. Further, an audio I/O 824 may be coupled to second interface 820. Note that other architectures than the point-to-point architecture described above are possible. For example, instead of the point-to-point architecture, a system such as multiprocessor system 800 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a co-processor including one or more special purpose cores intended primarily for graphics and/or scientific (throughput) computing. Such different processors lead to different computer system architectures, which may include: 1) the co-processor on a separate chip from the CPU; 2) the co-processor on a separate die in the same package as a CPU; 3) the co-processor on the same die as a CPU (in which case, such a co-processor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described co-processor, and additional functionality. Example core architectures are described next, followed by descriptions of example processors and computer architectures.

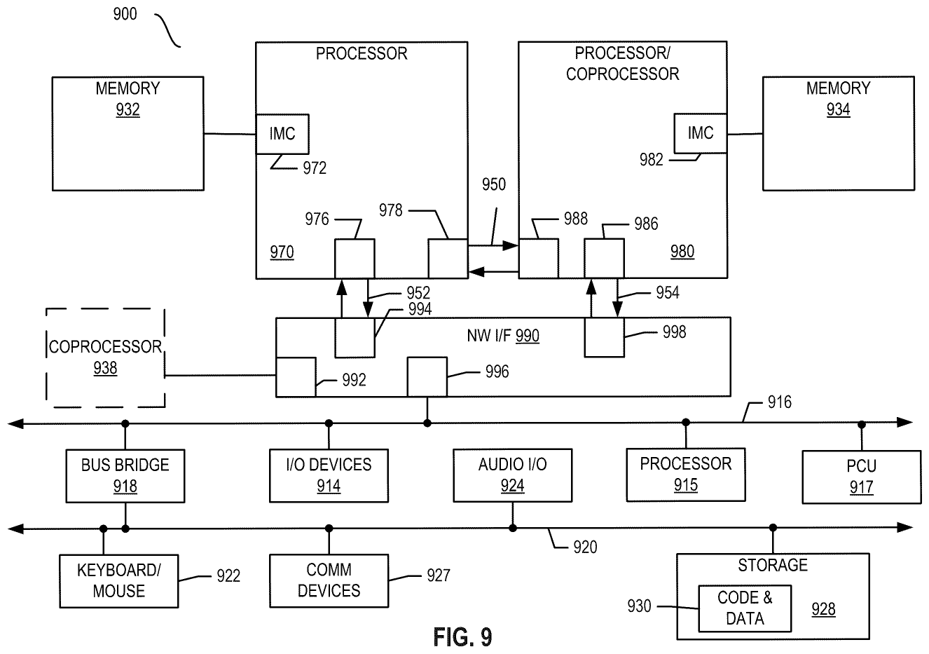

FIG. 9 illustrates a block diagram of an example processor and/or SoC 900 that may have one or more cores and an integrated memory controller. The solid lined boxes illustrate a processor and/or SoC 900 with a single core 902(A), system agent unit circuitry 910, and a set of one or more interface controller unit(s) circuitry 916, while the optional addition of the dashed lined boxes illustrates an alternative processor and/or SoC 900 with multiple cores 902(A)-(N), a set of one or more integrated memory controller unit(s) circuitry 914 in the system agent unit circuitry 910, and special purpose logic 908, as well as a set of one or more interface controller unit(s) circuitry 916. Note that the processor and/or SoC 900 may be one of the processors 870 or 880, or co-processor 838 or 815 of FIG. 8.

Thus, different implementations of the processor and/or SoC 900 may include: 1) a CPU with the special purpose logic 908 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like (which may include one or more cores, not shown), and the cores 902(A)-(N) being one or more general purpose cores (e.g., general purpose in-order cores, general purpose out-of-order cores, or a combination of the two); 2) a co-processor with the cores

902(A)-(N) being a large number of special purpose cores intended primarily for graphics and/or scientific (throughput); and 3) a co-processor with the cores 902(A)-(N) being a large number of general purpose in-order cores. Thus, the processor and/or SoC 900 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 900 may be a part of and/or may be implemented on one or more substrates using any of a number of process technologies, such as, for example, complementary metal oxide semiconductor (CMOS), bipolar CMOS (BICMOS), P-type metal oxide semiconductor (PMOS), or N-type metal oxide semiconductor (NMOS).

A memory hierarchy includes one or more levels of cache unit(s) circuitry 904(A)-(N) within the cores 902(A)-(N), a set of one or more shared cache unit(s) circuitry 906, and external memory (not shown) coupled to the set of integrated memory controller unit(s) circuitry 914. The set of one or more shared cache unit(s) circuitry 906 may include one or more mid-level caches, such as level 2 (L2), level 3 (L3), level 4 (L4), or other levels of cache, such as a last level cache (LLC), and/or combinations thereof. While in some examples interface network circuitry 912 (e.g., a ring interconnect) interfaces the special purpose logic 908 (e.g., integrated graphics logic), the set of shared cache unit(s) circuitry 906, and the system agent unit circuitry 910, alternative examples use any number of well-known techniques for interfacing such units. In some examples, coherency is maintained between one or more of the shared cache unit(s) circuitry 906 and cores 902(A)-(N). In some examples, interface controller unit(s) circuitry 916 couple the cores 902(A)-(N) to one or more other devices 918 such as one or more I/O devices, storage, one or more communication devices (e.g., wireless networking, wired networking, etc.), etc.

In some examples, one or more of the cores 902(A)-(N) are capable of multi-threading. The system agent unit circuitry 910 includes those components coordinating and operating cores 902(A)-(N). The system agent unit circuitry 910 may include, for example, power control unit (PCU) circuitry and/or display unit circuitry (not shown). The PCU may be or may include logic and components needed for regulating the power state of the cores 902(A)-(N) and/or the special purpose logic 908 (e.g., integrated graphics logic). The display unit circuitry is for driving one or more externally connected displays.

The cores 902(A)-(N) may be homogenous in terms of instruction set architecture (ISA). Alternatively, the cores 902(A)-(N) may be heterogeneous in terms of ISA; that is, a subset of the cores 902(A)-(N) may be capable of executing an ISA, while other cores may be capable of executing only a subset of that ISA or another ISA.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Embodiments described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoC with several flavors IPs, to the same process.

Enabling the use of multiple process technologies improves the time to market and provides a cost-effective way to create multiple product SKUs. For customers, this means getting products that are more tailored to their requirements in a cost effective and timely manner. Additionally, the disaggregated IPs are more amenable to being power gated independently, components that are not in use on a given workload can be powered off, reducing overall power consumption.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Examples may include, but are not limited to:

1. A non-transitory machine readable medium having stored thereon instructions which cause one or more processing devices to perform a method for processing image data in a convolutional neural network (CNN), comprising:
receiving an input image data;
generating a convolutional filter to be applied to the input image data, the convolutional filter selected from a plurality of filters based on two trainable parameters;
applying the convolutional filter to the input image data to generate filtered image data; and
outputting the filtered image data.

2. The non-transitory machine readable medium of example 1, wherein the plurality of filters comprises a family of filters.

3. The non-transitory machine readable medium of example 2, wherein the family of filters includes:
Gaussian filters, Difference of Gaussians filters, and Laplacian of Gaussian filters.

4. The non-transitory machine readable medium of example 2, wherein selecting the convolutional filters based on the two trainable parameters further comprises:
adjusting one or more of the two trainable parameters to select the convolutional filter from the family of filters.

5. The non-transitory machine readable medium of example 4, wherein the convolutional filter is used for training the CNN.

6. The non-transitory machine readable medium of example 1, further comprising dynamically adjusting a size of the convolutional filter during inference based on at least one of a confidence or scene complexity threshold.

7. The non-transitory machine readable medium of example 1, wherein applying the convolutional filter comprises:
applying a first filter of a first size to a border region of the input image data,
applying a second filter of the second size to a non-border region of the input image data, where in the second size is larger than the first size.

8. The non-transitory machine readable medium of example 6, wherein the first size is 3×3 and the second size is 5×5.

9. The non-transitory machine readable medium of example 1, wherein the image data is point cloud data.

10. A system comprising:
memory to store image data and a convolutional neural network (CNN);
a processor to:
   receive the image data
   generate a convolutional filter for the CNN to be applied to the input image data, the convolutional filter selected from a plurality of filters based on two trainable parameters;
   apply the convolutional filter to the input image data to generate filtered image data; and
   output the filtered image data.

11. The system of example 10, wherein the plurality of filters comprises a family of filters.

12. The system of example 11, wherein the family of filters includes Gaussian filters, Difference of Gaussians filters, and Laplacian of Gaussian filters.

13. The system of example 11, wherein to select the convolutional filters based on the two trainable parameters further comprises to adjust one or more of the two trainable parameters to select the convolutional filter from the family of filters.

14. The system of example 10, wherein the convolutional filter is used for training the CNN.

15. The system of example 10, wherein the processor is further to dynamically adjust a size of the convolutional filter during inference based on at least one of a confidence or scene complexity threshold.

16. The system of example 10, wherein to apply the convolutional filter comprises to:
apply a first filter of a first size to a border region of the input image data,
apply a second filter of the second size to a non-border region of the input image data, where in the second size is larger than the first size.

17. The system of example 16, wherein the first size is 3×3 and the second size is 5×5.

18. The system of example 10, wherein the image data is point cloud data.

19. A method for processing image data in a convolutional neural network (CNN) comprising:
receiving an input image data;
generating a convolutional filter to be applied to the input image data, the convolutional filter selected from a plurality of filters based on two trainable parameters;
applying the convolutional filter to the input image data to generate filtered image data; and
outputting the filtered image data.

20. The method of example 19, further comprising dynamically adjusting a size of the convolutional filter during inference based on at least one of a confidence or scene complexity threshold.

21. A non-transitory machine readable medium having stored thereon instructions which cause one or more processing devices to perform a method comprising:
receiving source data to process with a convolutional neural network (CNN), wherein an architecture of the CNN includes at least one mathematically defined kernel having at least one parameter learned during training of the CNN;
processing the source data with the CNN to generate an output; and
providing the output.

22. The non-transitory machine readable medium of example 21, wherein the at least one mathematically defined kernel having at least one learned parameter defines a Gaussian filter, difference of Gaussians filter, or Laplacian of Gaussians filter.

23. The non-transitory machine readable medium of example 21, wherein the source data is an image.

24. The non-transitory machine readable medium of example 21, wherein the at least one mathematically defined kernel having at least one parameter learned during training of the CNN is a fractional convolution kernel.

25. The non-transitory machine readable medium of example 21, further comprising:
training the CNN to learn the at least one parameter of the at least one mathematically defined kernel.

26. The non-transitory machine readable medium of example 21, wherein the architecture of the CNN is to support different sized kernels to be used at different locations of the source data.

27. The non-transitory machine readable medium of example 26, wherein a smaller kernel is to be applied to boundary data of the source data and a larger kernel is to be applied to interior data of the source data.

28. A non-transitory machine readable medium having stored thereon instructions which cause one or more processing devices to perform a method comprising:
receiving source data to process with a convolutional neural network (CNN), wherein an architecture of the CNN includes different sized kernels to be used at different locations of the source data;
processing the source data with the CNN to generate an output; and
providing the output.

29. The non-transitory machine readable medium of example 28, wherein a smaller kernel is to be applied to boundary data of the source data and a larger kernel is to be applied to interior data of the source data.

30. The non-transitory machine readable medium of example 28, wherein at least one of the different sized kernels is mathematically defined with a parameter learned during training.

31. The non-transitory machine readable medium of example 30, wherein the at least one of the different kernels that is mathematically defined is one of a Gaussian filter, difference of Gaussians filter, or Laplacian of Gaussians filter.

32. The non-transitory machine readable medium of example 30, further comprising:
training the CNN to learn the at least one parameter of the at least one mathematically defined kernel.

33. The non-transitory machine readable medium of example 28, wherein the source data is an image.

34. The non-transitory machine readable medium of example 28, wherein the source data is point cloud data.

35. A system comprising:
one or more computing systems to provide a multi-tenant storage service; and
one or more computing systems to provide a multi-tenant machine learning service, the machine learning service to:
   receive source data to process with a convolutional neural network (CNN), wherein an architecture of the CNN includes at least one mathematically defined kernel having at least one parameter learned during training of the CNN;
   process the source data with the CNN to generate an output; and
   provide the output.

36. The system of example 35, wherein the at least one mathematically defined kernel having at least one learned parameter defines a Gaussian filter, difference of Gaussians filter, or Laplacian of Gaussians filter.

37. The system of example 35, wherein the at least one mathematically defined kernel having at least one parameter learned during training of the CNN is a fractional convolution kernel.

38. The system of example 35, wherein the machine learning service is to:
train the CNN to learn the at least one parameter of the at least one mathematically defined kernel.

39. The system of example 35, wherein the architecture of the CNN is to support different sized kernels to be used at different locations of the source data.

40. The system of example 39, wherein a smaller kernel is to be applied to boundary data of the source data and a larger kernel is to be applied to interior data of the source data.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. A non-transitory machine readable medium having stored thereon instructions which cause one or more processing devices to perform a method for processing image data in a convolutional neural network (CNN), comprising:
receiving an input image data;
generating a convolutional filter to be applied to the input image data, the convolutional filter selected from a plurality of filters based on two trainable parameters;
applying the convolutional filter to the input image data to generate filtered image data; and
outputting the filtered image data.

2. The non-transitory machine readable medium of claim 1, wherein the plurality of filters comprises a family of filters.

3. The non-transitory machine readable medium of claim 2, wherein the family of filters includes Gaussian filters, Difference of Gaussians filters, and Laplacian of Gaussian filters.

4. The non-transitory machine readable medium of claim 2, wherein selecting the convolutional filters based on the two trainable parameters further comprises:
adjusting one or more of the two trainable parameters to select the convolutional filter from the family of filters.

5. The non-transitory machine readable medium of claim 4, wherein the convolutional filter is used for training the CNN.

6. The non-transitory machine readable medium of claim 1, further comprising dynamically adjusting a size of the convolutional filter during inference based on at least one of a confidence or scene complexity threshold.

7. The non-transitory machine readable medium of claim 1, wherein applying the convolutional filter comprises:
applying a first filter of a first size to a border region of the input image data, applying a second filter of the second size to a non-border region of the input image data, where in the second size is larger than the first size.

8. The non-transitory machine readable medium of claim 6, wherein the first size is 3×3 and the second size is 5×5.

9. The non-transitory machine readable medium of claim 1, wherein the image data is point cloud data.

10. A system comprising:
memory to store image data and a convolutional neural network (CNN);
a processor to:
receive the image data
generate a convolutional filter for the CNN to be applied to the input image data, the convolutional filter selected from a plurality of filters based on two trainable parameters;
apply the convolutional filter to the input image data to generate filtered image data; and
output the filtered image data.

11. The system of claim 10, wherein the plurality of filters comprises a family of filters.

12. The system of claim 11, wherein the family of filters includes Gaussian filters, Difference of Gaussians filters, and Laplacian of Gaussian filters.

13. The system of claim 11, wherein to select the convolutional filters based on the two trainable parameters further comprises to adjust one or more of the two trainable parameters to select the convolutional filter from the family of filters.

14. The system of claim 10, wherein the convolutional filter is used for training the CNN.

15. The system of claim 10, wherein the processor is further to dynamically adjust a size of the convolutional filter during inference based on at least one of a confidence or scene complexity threshold.

16. The system of claim 10, wherein to apply the convolutional filter comprises to:
apply a first filter of a first size to a border region of the input image data,
apply a second filter of the second size to a non-border region of the input image data, where in the second size is larger than the first size.

17. The system of claim 16, wherein the first size is 3×3 and the second size is 5×5.

18. The system of claim 10, wherein the image data is point cloud data.

19. A method for processing image data in a convolutional neural network (CNN) comprising:
receiving an input image data;
generating a convolutional filter to be applied to the input image data, the convolutional filter selected from a plurality of filters based on two trainable parameters;
applying the convolutional filter to the input image data to generate filtered image data; and
outputting the filtered image data.

20. The method of claim 19, further comprising dynamically adjusting a size of the convolutional filter during inference based on at least one of a confidence or scene complexity threshold.
